(19) United States
(12) Patent Application Publication
(10) Pub. No.: US 2023/0087938 A1
(43) Pub. Date: Mar. 23, 2023

(54) SYSTEMS AND METHODS FOR PRODUCING CHLORINE DIOXIDE

(71) Applicant: CHEME SOLUTIONS PROCESS ENGINEERING INC., Lake Stevens, WA (US)

(72) Inventor: Geoffrey Lawrence STENSLAND, Lake Stevens, WA (US)

(21) Appl. No.: 17/909,172

(22) PCT Filed: Jul. 30, 2021
(86) PCT No.: PCT/US2021/043906

§ 371 Date: Sep. 2, 2022

(51) Int. Cl. C01B 11/02; B01J 7/00; B01J 19/18; B01J 19/00

(52) U.S. Cl. CPC C01B 11/026; B01J 7/00; B01J 19/1818; B01J 19/0013

(57) ABSTRACT

Systems and methods for producing chlorine dioxide in a two stage system and single stage system that provides high chlorate to chlorine dioxide efficiency with a compact design and low sulfuric acid requirements.

### BACKGROUND

### Technical Field

The embodiments described herein relate to systems and methods for the production of chlorine dioxide, including systems and methods for producing chlorine dioxide that utilize chlorates salts, mineral acids and peroxides.

### Description of the Related Art

The production of chlorine dioxide using peroxide, sodium chlorate and sulfuric acid chemistry has been known for many years, For example, see U.S. Pat. No. 5,091,166. Some prior systems and methods for producing chlorine dioxide operated at 99% efficient and utilized temperatures near the boiling point for the solutions. Such systems are complex large scale implementations for producing chlorine dioxide and employ air and steam stripping and also salt separation making them complex systems to manage and operate. Such complex large-scale implementations are not practical for smaller production needs in the range of 1-200 lbs. per hr. of chlorine dioxide which make up a large percentage of all chlorine dioxide applications.

In rendering plants where animal byproducts materials are processed to produce products such as tallow, grease, high-protein meat and bone meal, chlorine dioxide has been proven to be an excellent choice in the treatment of plant air to reduce emission of foul odors. The preferred pH for the chlorine dioxide solution used for air odor control using rendering plant air scrubbers is in the range from between 4 to 10. When chlorine dioxide is used in rendering plant air scrubbers, it is usually utilized as an aqueous solution containing dissolved chlorine dioxide. Chlorine dioxide is also greatly utilized as a slime and bacteria treatment for industrial process water as well as drinking water. Other specific uses include odor control for bio solids, sewer collection systems and as an air scrubber additive in municipal systems.

A common production method for making chlorine dioxide on site is with the use of sodium chlorite, however this method requires the use of gaseous chlorine to be cost effective. As the water industry has moved to replace chlorine gas with bleach, the use of sodium chlorite to produce chlorine dioxide has required three chemicals to be used which have greatly increased the cost of production. A two-chemical solution to the high cost of producing chlorine dioxide from sodium chlorite uses sodium chlorate, hydrogen peroxide and sulfuric acid. In such two chemical solution, the sodium chlorate and peroxide components are provided as a “single chemical solution” in the form of a mixture. Using such a system removes the need to use sodium chlorite and also addresses safety issues associated with the use of chlorine gas to generate chlorine dioxide. As designed, processes that utilize this two chemical system are capable of producing large quantities of chlorine dioxide; however, such processes and systems that utilize such two chemical solution are not without their drawbacks, including:
A high level of excess sulfuric acid is needed in order to achieve high levels of conversion of chlorate to chlorine dioxide.
As the temperature of the reactants goes down, the need for additional acid may increase.
Under cold conditions salting out of the reactor may occur and efficiency may not meet the 95% requirement for drinking water applications.
When additional acid is needed to boost efficiency, high acid concentrations make the process at times thermally unstable leading to decomposing of chlorine dioxide to undesirable chlorine gas within the reactor.
Chemicals may be needed to reduce the pH of the produced solution of chlorine dioxide as the process demands a certain pH level higher than that desired in the end uses of the produced chlorine dioxide.

One source of an aqueous solution of chlorine dioxide are small-scale on-site chlorine dioxide generators. Such small-scale on-site chlorine dioxide generators react sodium chlorate, sulfuric acid and hydrogen peroxide to produce aqueous solutions of chlorine dioxide. By-products of this reaction include water, sodium sulfate and oxygen. These aqueous solutions of chlorine dioxide are typically produced using an excess of sulfuric acid. These solutions typically exhibit a pH of less than 2 and often must be treated before or after use in order to neutralize the unreacted acid in the aqueous chlorine dioxide solution before use, disposal or reuse of the solution.

One example of a process for producing chlorine dioxide on a small scale using excess acid is described in U.S. Pat. No. 6,790,427. This process can be characterized as a two chemical process where a mixture of sodium chlorate and hydrogen peroxide is combined with mineral acid which creates needed heat and acidity. Such method of chlorine dioxide generation utilizes large amounts of excess acid per unit of chlorine dioxide produced. The acid used in these types of processes is on the order of about four pounds per pound of chlorine dioxide produced. As noted above, in some cases these large amounts of excess acid require the use of expensive chemicals to raise the pH of the produced chlorine dioxide solution back up to where the process in which the chlorine dioxide solution will be utilized needs to run (e.g., air scrubbers). It is not unusual to spend 10 to 15% more capital on neutralization chemicals (per pound of chlorine dioxide produced) with such processes that utilize large amounts of excess acid. In addition, the use of highly concentrated acid (e.g., 78 wt %, 93 wt % or 98 wt % sulfuric acid) in the production of chlorine dioxide using sodium chlorate and hydrogen peroxide in the two chemical processes involves the mixing of the concentrated acid with the sodium chlorate and hydrogen peroxide mixture which can produce high localized temperatures sufficient to result in the chlorine dioxide undesirably decomposing to chlorine gas inside the reactor. Use of a less concentrated acid can reduce the localized heating but then requires the use of excess amounts of the acid solution having a lower concentration if acid (on the order of 4 lbs. of sulfuric acid per lb. of chlorine dioxide produced as noted above) to drive the reaction to desired levels of chlorine dioxide production.

### BRIEF SUMMARY

The approaches described herein address some of the issues which have limited adoption of on-site chlorine dioxide generation on smaller scales. The approaches described herein provide effective ways to produce chlorine dioxide utilizing chlorate salts, hydrogen peroxide and mineral acids. In some embodiments described herein, highly concentrated acid, e.g., 93 wt % or 98 wt % mineral acid is utilized. In addition, the approaches described herein provide a process that can be quickly started up, shut down safely and operated at different production rates. Described embodiments are relatively simple to implement and use. Embodiments described herein can be located and operated at sites which have chlorine dioxide demands on the order of 1 to 200 pounds per hour. In accordance with embodiments described herein, two to three chemicals are combined and reacted quickly to produce chlorine dioxide having a pH that does not require significant adjustment for applications such as drinking water or closed water systems such as air scrubbers or cooling towers.

In one aspect, embodiment of the subject matter described herein includes a system for producing chlorine dioxide that includes a source of sodium chlorate, a source of hydrogen peroxide and a source of sulfuric acid. A flow inducing device of the system induces a flow of the sodium chlorate, hydrogen peroxide and sulfuric acid into a primary reaction stage. The primary reaction stage includes a tubular vessel having a residence time of up to 60 seconds. Based on volumetric flow of the sodium chlorate, hydrogen peroxide and sulfuric acid into the tubular vessel of the primary reaction stage. The system further includes a secondary reaction stage in fluid communication with the primary reaction stage. The secondary reaction stage includes a tubular vessel having a residence time of less than 30 minutes, based on volumetric flow of fluid out of the primary reaction stage. The system further includes a source of thermal energy internal communication with the secondary reaction stage.

In another aspect, an embodiment of the present disclosure includes a method for producing chlorine dioxide that includes a step of contacting sodium chlorate, hydrogen peroxide and sulfuric acid in a primary reaction stage. The amount of sulfuric acid contacted with the sodium chlorate and the hydrogen peroxide is about 1.3 pounds to about 3.5 pounds of sulfuric acid per pound of chlorine dioxide to be produced. The sodium chlorate, hydrogen peroxide and sulfuric acid are reacted in the primary reaction stage.

Within the primary reaction stage, 50% or more of the sodium chlorate is consumed within 60 seconds of the sodium chlorate, hydrogen peroxide and sulfuric acid coming in contact with each other in the primary reaction stage. Contents from the primary reaction stage discharge from the top of the primary reaction stage and are delivered to a bottom one third of a secondary reaction stage. In some embodiments, the contents of the secondary reaction stage are maintained below 200° F. In some embodiments, the contents of the secondary reaction stage are maintained below 160-180° F. Additional chlorine dioxide is produced in the secondary reaction stage.

### BRIEF DESCRIPTION OF THE SEVERAL VIEWS OF THE DRAWINGS

In the drawings, the sizes and relative positions of elements in the drawings are not necessarily drawn to scale. For example, the shapes of various elements and angles are not drawn to scale, and some of these elements are arbitrarily enlarged and positioned to improve drawing legibility.

Further, the particular shapes of the elements as drawn are not intended to convey any information regarding the actual shape of the particular elements, and they have been solely selected for ease of recognition in the drawings.

FIG. 1 is a schematic illustration of a piping diagram of a two stage chlorine dioxide generator according to a non-limiting embodiment of the subject matter described herein.

FIG. 2 is a schematic illustration of a piping diagram of a two-stage chlorine dioxide generator according to a non-limiting embodiment of the subject matter described herein.

FIG. 3 is a schematic illustration of a piping diagram of a two stage chlorine dioxide generator according to a non-limiting embodiment of the subject matter described herein.

FIG. 4 is a plot of chlorate conversion efficiency versus time for a two-stage chlorine dioxide generator operated at an acid level in accordance with an embodiment described herein, and a two-stage chlorine dioxide generator operated at a higher acid level.

FIG. 5 is a plot of chlorate conversion efficiency versus time for a two-stage chlorine dioxide generator that has a heated secondary reaction stage, in accordance with embodiments described herein, and a two-stage chlorine dioxide generator that has a secondary reaction stage that is not heated.

FIG. 6 is a plot of chlorate conversion efficiency versus time for a two-stage chlorine dioxide generator that includes different lengths of primary reaction stages in accordance with embodiments described herein.

FIG. 7A is a cross-section of an embodiment of a mixing block in accordance with the present disclosure.

FIG. 7B is a top view of a mixing block in accordance with an embodiment of the present disclosure.

FIG. 8 is an image of an embodiment of a mixing block in accordance with the present disclosure.

FIG. 9 is an image of an embodiment of a top of a mixing block in accordance with the present disclosure.

FIG. 10 is a flow diagram illustrating a method carried out in accordance with an embodiment of the subject matter described herein.

FIG. 11 is a plot of chlorate conversion efficiency versus time for operation of the system in accordance with the present disclosure where a mixture of the sodium chlorate and hydrogen peroxide are heated to different temperatures prior to feeding to the primary reaction stage.

FIG. 12 is a schematic illustration of a piping diagram of a two stage chlorine dioxide generator according to a non-limiting embodiment of the subject matter described herein.

FIG. 13 is a schematic illustration of a piping diagram of a single stage chlorine dioxide generator according to a nonlimiting embodiment of the subject matter described herein.

FIG. 14 is a flow diagram illustrating a method carried out in accordance with an embodiment of the subject matter described herein.

### DETAILED DESCRIPTION

It will be appreciated that, although specific embodiments of the present disclosure are described herein for purposes of illustration, various modifications may be made without departing from the spirit and scope of the present disclosure. Accordingly, the present disclosure is not limited except as by the appended claims.

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with reactors for producing chlorine dioxide from sodium chlorate, sulfuric acid and hydrogen peroxide have not been shown or described in detail to avoid unnecessarily obscuring descriptions of the embodiments.

Unless the context requires otherwise, throughout the specification and claims that follow, the word “comprise” and variations thereof, such as “comprises” and “comprising” are to be construed in an open, inclusive sense, that is, as “including, but not limited to.”

Reference throughout the specification to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same aspect. Furthermore, the particular features, structures, or characteristics may be combined in any suitable manner in one or more aspects of the present disclosure.

The use of ordinals such as first, second and third does not necessarily imply a ranked sense of order, but rather may only distinguish between multiple instances of an act or structure.

In the figures, identical reference numbers identify similar features or elements. The sizes and relative positions of the features in the figures are not necessarily drawn to scale.

As used herein, the term reactor or generator refers to a combination of two or more reactor vessels or stages and other fluid processing equipment such as circulation pumps, piping, heat exchangers, heaters, temperature and pressure sensors, eductor and instrumentation to maintain desired process conditions.

In accordance with one embodiment described herein alkali metal chlorate, e.g., sodium chlorate, and mineral acid, e.g., sulfuric acid, are combined in a mixing chamber formed in accordance with embodiments described herein to form a single mixture that is delivered to a chlorine dioxide generator where the mixture is combined with hydrogen peroxide and reacts with the hydrogen peroxide to form chlorine dioxide.

In accordance with some embodiments of systems and methods described herein for producing chlorine dioxide, an aqueous solution containing chlorine dioxide is produced that has a pH on the order of 3 or more and in other embodiments on the order of 4 or more. Neutralizing an aqueous solution having a pH of about 3 provides cost savings on the order of 3 over costs involved in neutralizing an aqueous solution have a pH of about 2, e.g., chlorine dioxide containing solutions have a pH of about 2. Neutralizing an aqueous solution having a pH of about 4 or more provides even more cost savings compared to the cost savings realized from neutralizing an aqueous solution having a pH of about 3.

Systems and methods for producing chlorine dioxide in accordance with embodiments described herein utilize a chlorate salt, a peroxide and the mineral acid as separate feedstocks. In some embodiments, chlorine dioxide is produced utilizing a mixture of chlorate salt and peroxide as one feedstock and a mineral acid as a second feedstock. In some embodiments, the mineral acid has an acid content of about 78% and in other embodiments, the mineral acid has an acid content about 93% or greater, e.g., 97% or 98%. In other embodiments, the mineral acid has an acid concentration of less than about 78%, for example, less than about 70% or less than about 60%. An example of a mineral acid having an acid content less than about 78% is a sulfuric acid having an acid concentration of about 50%.

Embodiments in accordance with the present disclosure produce chlorine dioxide utilizing low amounts of mineral acid, e.g., about 1.3 to about 3.0 lbs acid per lb. of chlorine dioxide produced and exhibit chlorate conversion values of greater than 90% or greater than 95%. Chlorate conversion value refers to a percentage calculated as 1 minus (the difference between amount of chlorate into the system and amount of chlorate out of the system)/amount of chlorate into the system. As used herein, the reference to lbs of acid per lb. of chlorine dioxide produced refers to lbs of pure acid. In other words, 2 lbs of 78% acid is equivalent to 1.56 lbs of pure acid, i.e., 2 lbs of 78% acid×0.78=1.56 lbs pure acid. Utilizing the amounts of mineral acid per some embodiments of the present disclosure produces an aqueous chlorine dioxide solution having a pH less than about 4, less than about 3 and in some embodiments less than about 2. Such aqueous chlorine dioxide solutions require less neutralizing chemicals in order to increase the pH of the aqueous chlorine dioxide solution to a level suitable for the intended use or render the used chlorine dioxide solution suitable for disposal or reuse. In accordance with some aspects of the systems and methods described herein, chlorine dioxide is produced with low risk of chlorine dioxide decomposing to undesirable chlorine gas.

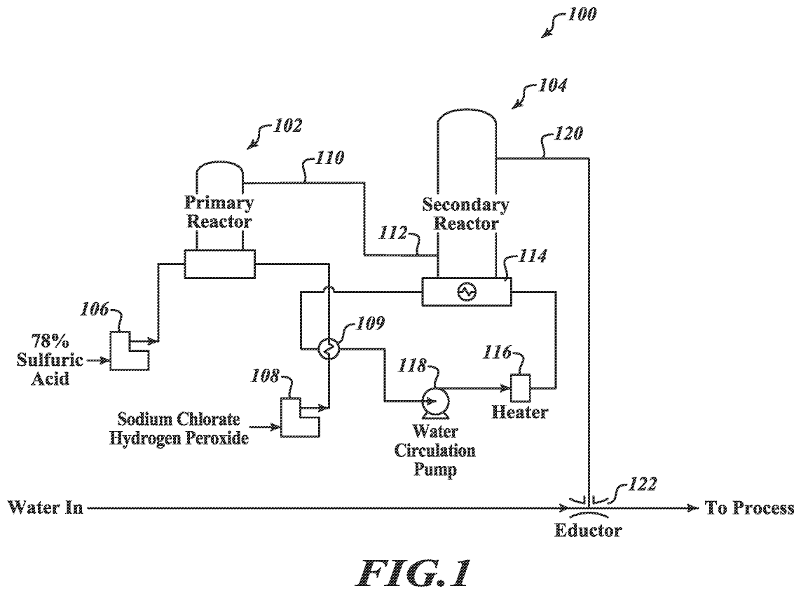

Referring to FIG. 1, in accordance with an embodiment of the present disclosure, a system 100 for producing chlorine dioxide includes a primary reaction stage (or reactor or generator) 102 and a secondary reaction stage 104 (or reactor or generator). Details of the primary reaction stage 102 and secondary reaction stage 104 are described below in more detail. System 100 further includes a source of mineral acid 106, e.g., 78% sulfuric acid, and a source 108 of a mixture of a chlorate salt and a peroxide, e.g., sodium chlorate and hydrogen peroxide, in fluid communication with primary reactor 102. In the illustrated embodiment, the source of sulfuric acid 106 and the source of the mixture of sodium chlorate and hydrogen peroxide 108 are in fluid communication with a bottom of primary reaction stage 102; however, embodiments in accordance with the present disclosure are not limited to the source of sulfuric acid 106 and the source of the mixture of sodium chlorate and hydrogen peroxide 108 being in fluid communication with a bottom of the primary reaction stage 102. For example, in accordance with other embodiments, the source of sulfuric acid 106 and the source of the mixture of sodium chlorate and hydrogen peroxide 108 are in fluid communication with portions of the primary reaction stage 102 other than its bottom, e.g., a middle section or top section of the primary reaction stage 102. In the illustrated embodiment, a source of thermal energy 109, e.g., a heater or heat exchanger, is located between the source of sodium chlorate and hydrogen peroxide 108 and primary reaction stage 102 such that the source of thermal energy 109 is able to introduce thermal energy into the sodium chlorate and hydrogen peroxide that enters the primary reaction stage 102.

An upper portion of primary reaction stage 102 is in fluid communication with the secondary reaction stage 104. In the illustrated embodiment, such fluid communication is provided by an outlet 110 of primary reaction stage 102 in the top section, i.e., upper one third, of primary reaction stage 102, and an inlet 112 of secondary reaction stage 104, which is located in a bottom section, i.e., lower one third of secondary reaction stage 104. In accordance with embodiments of the present disclosure, the location of outlet 110 need not be in the top section of primary reaction stage 102 , provided that outlet 110 is positioned at an elevation above inlet 112 of secondary reaction stage 104. Similarly, inlet 112 of secondary reaction stage 104 need not be located in the bottom section of secondary reaction stage 104, provided that inlet 112 is located at an elevation below outlet 110.

In the illustrated embodiment of FIG. 1, the bottom of secondary reaction stage 104 is in thermal communication with a source of thermal energy 114. In other embodiments in accordance with the present disclosure, source of thermal energy 114 positioned at a location other than the bottom of secondary reaction stage 104. For example, in some embodiments, source of thermal energy 114 is located at some distance removed from the bottom of the secondary reaction stage, e.g. is located within the bottom one third of secondary reaction stage 104, within the middle section, i.e., middle one third of secondary reaction stage 104 or within the top section, top one third of secondary reaction stage 104. Source of thermal energy 114 is an electric or non-electric powered heater or a heat exchanger or any other device suitable for generating thermal energy for introduction into the secondary reaction stage 104 or for transferring thermal energy into a secondary reaction stage 104. In the illustrated embodiment, source of thermal energy 114 is a heat exchanger. One side of the heat exchanger carries a heating fluid, such as water or a coolant. The heating fluid is pumped through a heater 116 by a pump 118. The other side of the heat exchanger carries fluid from within the secondary reaction stage 104. In accordance with an embodiment of the present disclosure, thermal energy from the heating fluid is transferred to fluid within the secondary reaction stage 104. Chlorine dioxide produced in secondary reaction stage 104, exits secondary reaction stage 104 at outlet 120 located in the top section of secondary reaction stage 104. In the illustrated embodiment, an educator 122 creates a pressure differential which draws the contents of the secondary reaction stage 104. The heating fluid that exits heat exchanger 114 is delivered to heat exchanger 109 where thermal energy from the heating fluid is transferred to the sodium chlorate and hydrogen peroxide.

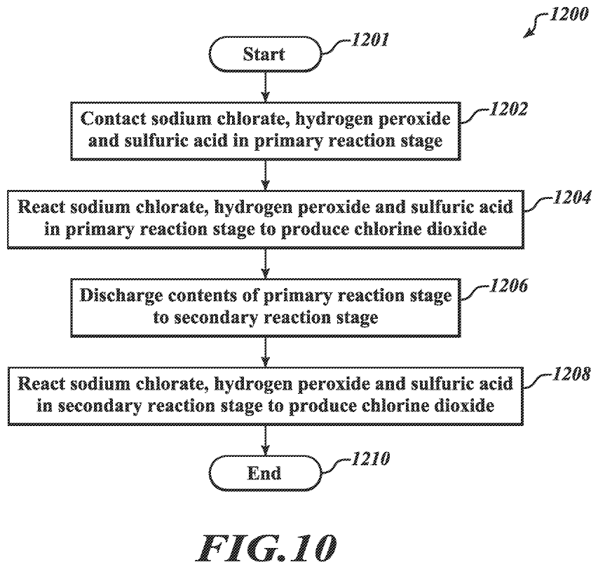

A method carried out in accordance with an embodiment of the present disclosure will be described with reference to FIG. 1 and FIG. 10. The description of various embodiments here refers to sodium chlorate as an example of a chlorate salt, sulfuric acid as an example of a mineral acid, and hydrogen peroxide as an example of a reducing agent. Embodiments described herein are not limited to these specific chlorate salt, mineral acid and reducing agent. Examples of other reducing agents for producing chlorine dioxide from sodium chlorate include sulfur dioxide, methanol and hydrochloric acid. Other examples of a mineral acid include hydrochloric acid HClI. Other examples of chlorates salts include potassium chlorate.

In FIG. 10, the illustrated embodiment of method 1200 starts at step 1201. At step 1202, 78% sulfuric acid from source of sulfuric acid 106 is pumped into the bottom of primary reaction stage 102. The amount of sulfuric acid pumped into the bottom of the primary reaction stage is sufficient to provide between about 1.3 lbs to 3.0 lbs of acid per lb. of chlorine dioxide to be produced. At step 1202, the mixture of sodium chlorate and hydrogen peroxide from source of sodium chloride and hydrogen peroxide 108 is pumped into the bottom of primary reaction stage 102. In accordance with some embodiments of the present disclosure, the mixture of sodium chlorate and hydrogen peroxide contains 30-45% percent sodium chlorate and 4-12% hydrogen peroxide. Other embodiments of the present disclosure are not limited to mixtures including the foregoing amounts of sodium chlorate/hydrogen peroxide. In the illustrated embodiment, the amount of the mixture of sodium chlorate and hydrogen peroxide utilized is between about 3.5-5.5 lbs of the mixture per lb. of chlorine dioxide to be produced. Other embodiments of the present disclosure are not limited to the foregoing amount of the mixture of sodium chlorate and hydrogen peroxide and use amounts of the mixture that fall below or above the foregoing range. In some embodiments, temperature of the mixture of sodium chlorate and hydrogen peroxide is increased by the introduction of thermal energy from thermal energy source 109. The degree to which the temperature of the mixture of sodium chlorate and hydrogen peroxide is increased can vary;

however, in some embodiments, the temperature of the mixture is increased by 10 to 100° F. over ambient temperature. In other embodiments, the temperature of the mixture is increased less than 10° F. or the temperature of the mixture is increased more than 100° F. In other embodiments, the temperature of the sodium chlorate and hydrogen peroxide mixture is increased, but not in excess of 170° F. At step 1204, a portion of the sodium chlorate, hydrogen peroxide and sulfuric acid introduced into primary reaction stage 102 reacts to produce chlorine dioxide. In some embodiments, conditions within primary reaction stage 102 are controlled so that 50% or more of the sodium chlorate delivered to the primary reaction vessel is consumed by the reaction within the primary reaction vessel 102. In some embodiments, the residence time of the primary reaction vessel is less than about 60 seconds and the contents of the primary reaction vessel 102 are at a temperature that is not greater than 160° F. In other embodiments, the contents of the primary reaction vessel 102 are at a temperature that is not greater than about 170° F., e.g., below about 170° F. Embodiments in accordance with the present disclosure are not limited to a primary reaction stage 102 having a residence time less than about 60 seconds. For example, primary reaction stage 102 can have a residence time less than about 60 seconds, e.g., less than 50 seconds, less than 45 seconds, less than 40 seconds, less than 35 seconds or less than 30 seconds. In other embodiments, primary reaction stage 102 has a residence time greater than 60 seconds, e.g. , greater than 65 seconds, greater than 70 seconds, greater than 75 seconds, greater than 80 seconds, greater than 85 seconds or greater than 90 seconds. The particular residence time designed into the primary reaction stage is chosen so that the response time in the primary reaction stage is quicker than if the residence time of the primary reaction stage were to be much greater than 60 seconds. The desired response times are at least in part due to the lower acidity of the contents in the primary reaction stage, which if not preheated to higher temperatures would not have enough heat to produce quickly produce chlorine dioxide. As the unreacted chlorate from the first reaction stage proceeds to the second reaction stage where it comes in contact with the pool of hot liquid in the secondary reaction stage, the chlorine peroxide producing reaction proceeds very quickly. In other embodiments, the temperature of the contents of the primary reaction vessel 102 is less than 140° F., less than 160° F. or less than 170° F. For example, in some embodiments of the present disclosure, the temperature of the contents of the primary reaction vessel 102 is between ambient temperature and 110° F., 120° F., 130° F., 140° F. or 150° F. The particular temperature of the contents of the primary reaction stage is chosen so that the chlorine dioxide producing reaction in the primary reaction stage does not generate so much thermal energy that decomposition of hydrogen peroxide occurs in the second reaction stage. In addition, if the contents of the primary or secondary reaction stage become too hot, e.g., above 170 degrees F. or above 200 degrees F., chlorine dioxide can decompose.

In accordance with an embodiment illustrated in FIG. 10, the amount of sulfuric acid delivered to the primary reaction stage 102 ranges from about 1.3 pounds to about 3.0 pounds of sulfuric acid per pound of chlorine dioxide to be produced. In other embodiments, the amount of sulfuric acid delivered to the primary reaction stage 102 ranges from about 1.3 pounds to about 3.5 pounds of sulfuric acid per pound of chlorine dioxide to be produced or 1.5 pounds to about 3.5 pounds of sulfuric acid per pound of chlorine dioxide to be produced. Embodiments in accordance with the present disclosure are not limited to the foregoing amounts of sulfuric acid. For example, in other embodiments, the amount of sulfuric acid is between about 1.5 and 2.5 pounds of sulfuric acid per pound of chlorine dioxide to be produced. In other embodiments, the amount of sulfuric acid is between about 1.8 to about 2.2 pounds of sulfuric acid per pound of chlorine dioxide to be produced. In other embodiments, the amount of sulfuric acid is less than 1.3 pounds per pound of chlorine dioxide to be produced, e.g., less than 1.2 lbs., less than 1.1 lbs. or less than 1.0 lbs. of sulfuric acid per pound of chlorine dioxide to be produced. In other examples, the amount of sulfuric acid is between 3.0 pounds of sulfuric acid per pound of chlorine dioxide to be produced and less than 4 lbs of sulfuric acid per lb. of chlorine dioxide to be produced. For example, the amount of sulfuric is less than 4 lbs of sulfuric acid per pound of chlorine dioxide to be produced and greater that about 2.1 pounds, 2.2 pounds, 2.3 pounds, 2.4 pounds, 2.5 pounds, 3 lbs., 3.1 lbs., 3.2 lbs., 3.3 lbs. or 3.4 lbs of sulfuric acid per pound of chlorine dioxide to be produced.

In step 1204, as noted above, a portion of the sodium chlorate, hydrogen peroxide and sulfuric acid reacts in primary reaction stage 102 to produce chlorine dioxide. This chlorine dioxide and unreacted sodium chlorate, unreacted hydrogen peroxide and unreacted sulfuric acid from primary reaction stage 102, and any resulting reaction by-products (e.g., sodium sulfate and water) are discharged at step 1206 from primary reactor 102 through outlet 110 and into secondary reaction stage 104 through inlet 112. At step 1208, the sodium chlorate, hydrogen peroxide and sulfuric acid in secondary reaction stage 104 reacts to produce additional chlorine dioxide. In an embodiment, the residence time of the secondary reaction stage 104 is at least 15 minutes. Embodiments of the present disclosure are not limited to residence times of the secondary reaction stage 104 being at least 15 minutes. For example, the residence time of the secondary reaction stage 104 can be less than 15 minutes, for example, less than 15 minutes and at least 5 minutes, at least 6 minutes, at least 7 minutes, at least 8 minutes, at least 9 minutes, at least 10 minutes, at least 11 minutes, at least 12 minutes, at least 13 minutes, or at least 14 minutes. The secondary reactor stage is designed so to provide a minimum residence time required to achieve 95% efficiency to chlorine dioxide. The smaller reaction stages in accordance with some embodiments of the present disclosure allows for the overall chlorine dioxide generation system to be small and compact. The smaller reaction stages also support a shutdown process that is quick and does not send a large amount of reactor contents into the process during shutdown.

In accordance with the embodiment of FIG. 1, the normality of the contents of the secondary reaction stage 104 is below 11. In other embodiments, the normality of the contents of the secondary reaction stage is below 10. In some embodiments, the sodium chlorate in the secondary reaction stage has molarity of less than one and in other embodiments, the sodium chlorate in the secondary reaction stage has molarity of less than 0.5.

In accordance with the embodiment of FIGS. 1 and 10, the temperature of the contents of the secondary reaction stage 104 is below 172° F. or below 200° F. and not below 130° or not below 120° F. In other embodiments, the temperature of the contents of the secondary reaction stage 104 is not below 135° F., not below 140° F. or not below 145° F. For example, in some embodiments the temperature of the contents of the secondary reaction stage 104 is between about 145° F. to 160° F. The upper end of the temperature range for the contents of the secondary reaction stage 104 is chosen so that chlorine dioxide within the secondary reaction stage does not begin to decompose to chlorine gas. It has been observed that when reactor chlorate molarity of 0.5 is used, the conversion of reactants to chlorine dioxide is about 5 times faster at a temperature of about 160° F. vs 140° F. It has also been observed that once a blend of 160° acid at a normality of 8-11 is mixed with a chlorate to achieve a chlorate molarity of about 0.5, chlorine dioxide is produced in a near instantaneous manner. These observations indicate the if the temperature of the contents in the secondary reaction stage is in the 160° F. range and contents have a chlorate in excess of about 0.5 molarity is introduced, the reaction is nearly instantaneous and 95% efficiency is be achieved.

In accordance with some embodiments in accordance with the present disclosure, the overall conversion of sodium chlorate to chlorine dioxide provided by the reactions that occur in primary reaction stage 102 and secondary reaction stage 104 is at least 90%. The term “overall conversion” refers to the amount of sodium chlorate fed to the primary reaction stage that is consumed in the primary reaction stage and the secondary reaction stage. For example, a 90% overall conversion means that of 100 lbs of the sodium chlorate entering the primary reaction stage, 90 lbs. are consumed in the primary reaction stage 102 and the secondary reaction stage 104. Stated another way, this 90% conversion would result in 10 lbs. of sodium chlorate leaving the secondary reaction stage 104. In other embodiments, the overall conversion of sodium chlorate to chlorine dioxide provided by the reactions that occur in primary reaction stage 102 and secondary reaction stage 104 in accordance with the present disclosure is at least 95% or higher.

The process of FIG. 10 ends at step 1210 and the contents of the secondary reaction stage 104 (including the chlorine dioxide) are removed from the secondary reaction stage 104 via outlet 120.

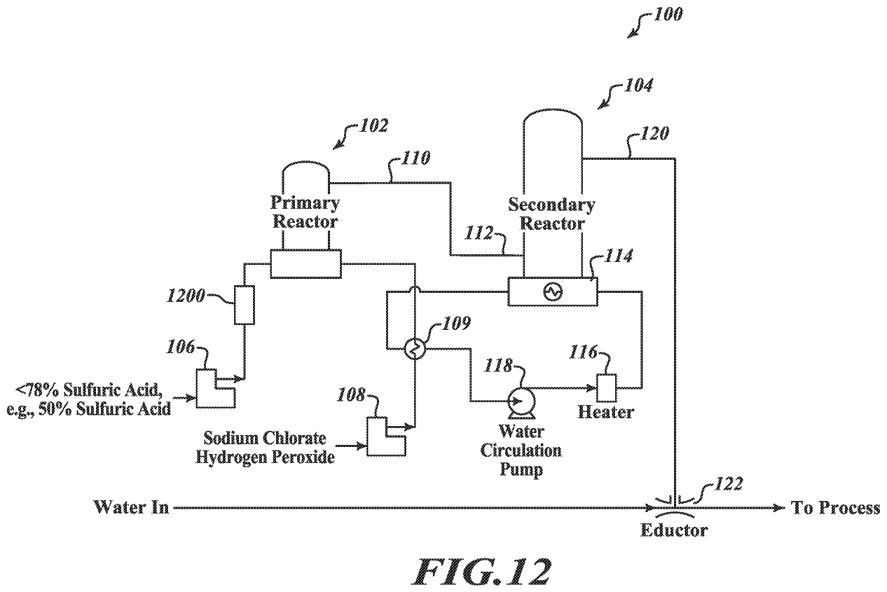

Referring to FIG. 12, in another embodiment of the present disclosure, a system for producing chlorine dioxide is illustrated. The embodiment illustrated in FIG. 12 is similar to the embodiment of FIG. 1. The features of the embodiment illustrated in FIG. 12 that are common with the features of the embodiment illustrated in FIG. 1 are identified with the same reference numerals used in FIG. 1. The embodiment of FIG. 12 differs from the embodiment of FIG. 1 in that the mineral acid employed is sulfuric acid having an acid concentration of 78% or less, for example, 50% sulfuric acid. Unlike the embodiment of FIG. 1 in which the mineral acid is not heated prior to contacting it with the sodium chlorate and hydrogen peroxide in the primary reactor 102, in the embodiment of FIG. 12, the mineral acid is heated prior to contacting the mineral acid with the sodium chlorate and hydrogen peroxide in the primary reactor 102. The embodiment of FIG. 12 includes a heater or heat exchanger 1200 for introducing thermal energy into the sulfuric acid prior to delivery of the sulfuric acid to the primary reactor 102. In accordance with this embodiment of the present disclosure, the thermal energy added to the sulfuric acid by heater 1200 elevates the temperature of the acid to within a range of about 120° to 140° F. In other embodiments, the thermal energy added to the sulfuric acid by heater 1200 elevates the temperature of the acid to a range within about 115° F. to about 160° F. or even as high as about 170° F. In other embodiments, the temperature of the acid is elevated to within a range of about 125° F. to about 135° F. In yet other embodiments, the thermal energy added to the sulfuric acid raises the temperature of the sulfuric acid to about 130° F. Embodiments in accordance with this disclosure are not limited to elevating the temperature of the sulfuric acid to the above ranges. For example, in other embodiments, the temperature of the sulfuric acid can be adjusted to temperatures outside the foregoing ranges or values. For example, in some embodiments, the temperature of the sulfuric acid can be elevated to above 170° F.

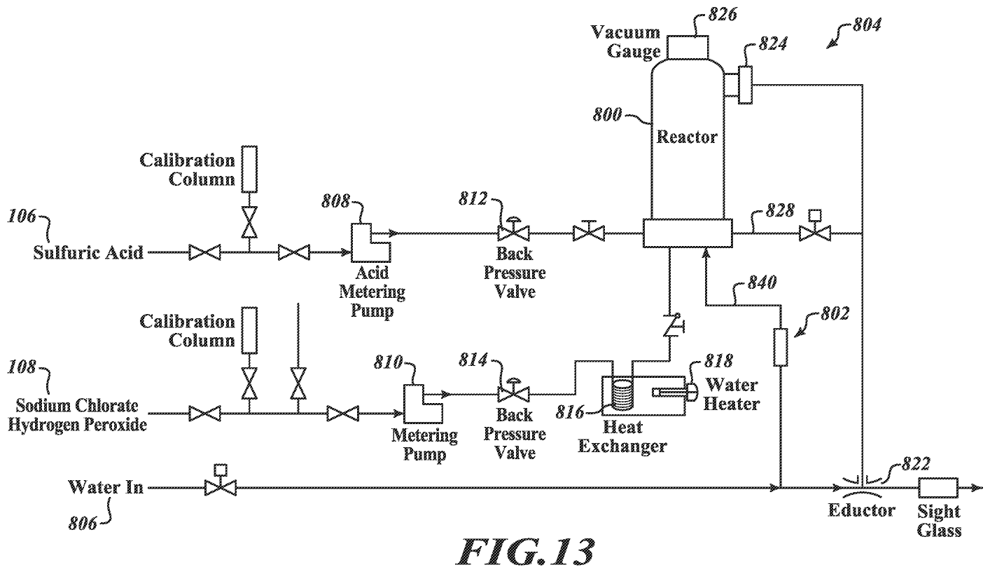

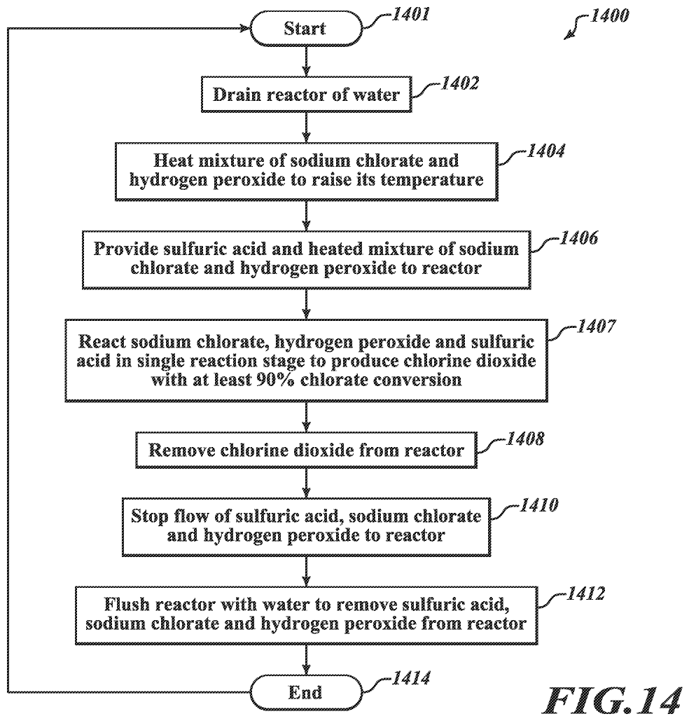

Referring to FIG. 13, in another embodiment of the present disclosure, a system 804 for producing chlorine dioxide utilizing a single reactor is illustrated. The embodiment illustrated in FIG. 13 is similar to the embodiment of FIG. 1 in that it utilizes a sulfuric acid, which has a concentration greater than 50% and less than 80%, e.g., 78% sulfuric acid, and a mixture of sodium chlorate and hydrogen peroxide. In some embodiments, system 804 is configured to produce amounts of chlorine dioxide on the order of 5 lbs/hour with about 95% chlorate conversion. Embodiments in accordance with FIG. 13 are not limited to those that produce chlorine dioxide on the order of 5 lbs/hour or that achieve 95% chlorate conversion. For example, in other embodiments in accordance with FIG. 13, system 804 produces more than 5 pounds per hour of chlorine dioxide and in other embodiments produces less than 5 pounds per hour of chlorine dioxide. Similarly, in other embodiments in accordance with FIG. 13, chlorate conversion may be less than 95% or greater than 95%. In addition, in the embodiment of FIG. 13, the mixture of sodium chlorate and hydrogen peroxide is heated prior to it coming into contact with the sulfuric acid having a concentration greater than 50% and less than 80%, e.g., 78% sulfuric acid. The features of the embodiment illustrated in FIG. 13 that are common with the features of the embodiment illustrated in FIG. 1 are identified with the same reference numerals used in FIG. 1. In addition, embodiments in accordance with FIGS. 13 and 14 are described with reference to 78% sulfuric acid; however, embodiments in accordance with FIGS. 13 and 14 are not limited to use of 78% sulfuric acid.

The embodiment of FIG. 13 differs from the embodiment of FIG. 1 in that only a single reactor 800 is utilized. Reactor 800 includes a valving assembly 802 described below in more detail. Valving assembly 802 includes a one or more valves (not shown) configured to supply reactor 800 with water, for example to flush the reactor upon shut down or at other times when flushing reactor 800 is desired. Valving assembly 802 may be automated so that delivery of water to reactor 800 occurs automatically before startup or upon shutdown of reactor 800. For example, operation of valving assembly 802 to deliver water to reactor 800 can be controlled by a control system (not shown for the system 804). Valving assembly 802 is operated to deliver water to reactor 800 immediately after shut down of reactor 800. The water delivered to reactor 800 immediately upon shutdown flushes out sodium chlorate, hydrogen peroxide, sulfuric acid and chlorine dioxide that is present within the reactor 800 upon shutdown. In accordance with embodiments of the present disclosure, the water that displaces the sodium chlorate, hydrogen peroxide, sulfuric acid and chlorine dioxide upon shutdown is retained within the reactor 800 until the reactor is started up again.

In accordance with an embodiment of the present disclosure, startup of reactor 800 includes draining of water from reactor 800 before startup. This draining removes water that is present in reactor 800 as a result of a safe shutdown procedure which requires that the reactor be flushed with water at shutdown and that water be retained within reactor 800 while it is dormant. Draining reactor 800 of water immediately before startup reduces the amount of time required to start up reactor 800 compared to the time required to start up reactor 800 without draining the water resulting from flushing of the reactor 800 at shutdown and introducing the reactants (mixture of sodium chlorate and hydrogen peroxide and sulfuric acid) directly into the reactor which is full of water. For example, when reactor 800 has a volume of 15 liters, production of chlorine dioxide in reactor 800 (as evidenced by chlorine dioxide exiting reactor 800 via chlorine dioxide outlet 824) without draining the reactor prior to introducing the sulfuric acid and mixture of sodium chlorate and hydrogen peroxide can take on the order of 15-30 minutes. On the other hand, when reactor 800 is drained of water prior to introducing the sulfuric acid and mixture of sodium chlorate and hydrogen peroxide into reactor 800, chlorine dioxide is produced within about 5 minutes.

Continuing to refer to FIG. 13, chlorine dioxide producing system 804 includes reactor 800, valving assembly 802, source of sulfuric acid 106, source of mixture of sodium chlorate and hydrogen peroxide 108, source of water 806, acid metering pump 808, water metering pump 810, back pressure valves 812 and 814, heat exchanger 816, water heater 818 and eductor 822. Chlorine dioxide producing system 804 also includes valves V1, V2, B3, V4, V5, V6, V7 and V30. In some embodiments, chlorine dioxide producing system 804 is provided with a calibration column for the sulfuric acid and a calibration column for the mixture of sodium chlorate and hydrogen peroxide. Reactor 800 further includes a chlorine dioxide outlet 824 and a vacuum gauge 826. In another embodiment, reactor 800 is provided with a source of external thermal energy, e.g., a heater or heat exchanger. This source of external thermal energy provides thermal energy to reactor 800 over and beyond thermal energy that is carried into the reactor by the sulfuric acid, sodium chlorate and hydrogen peroxide.

In accordance with some embodiments, reactor 800 has a volume that is between 0.5 liters per pound of chlorine dioxide produced per hour and 1.5 liters per pound of chlorine dioxide produced per hour. For example, when reactor 800 produces 5 pounds of chlorine dioxide per hour, reactor 800 will have a volume between 2.5 liters and 7.5 liters. Embodiments in accordance with FIG. 13 are not limited to reactors that have a volume between 0.5 liters per pound of chlorine dioxide produced per hour and 1.5 liters per pound of chlorine dioxide produced per hour. For example, in other embodiments, reactor 800 can have a volume that is less than 0.5 liters per pound of chlorine dioxide produced per hour or a volume that is greater than 1.5 liters per pound of chlorine dioxide produced per hour.

Though not illustrated in FIG. 13, reactor 800 of system 804 can include a source of thermal energy which provides thermal energy to the bottom of reactor 800. See the discussion regarding FIG. 1 and FIG. 12 regarding heat exchanger 109, heat exchanger 114, heater 116 and pump 118 which is equally applicable to the system of FIG. 13. Embodiments in accordance with the present disclosure are not limited to providing thermal energy to the bottom of reactors 104 or 800 using heat exchangers 109 and 114, heater 116 and pump 118. For example, thermal energy can be provided using other hardware, for example an electric or steam powered heating coil in the bottom of reactors 104 or 800.

Referring to FIG. 14 a flow diagram of a method 1400 for producing chlorine dioxide utilizing a single reactor, such as the reactor 800, illustrated in FIG. 13 is described with reference to the components of the chlorine dioxide producing system 804. Method 1400 begins at step 1401. At step 1402, startup of a reactor is initiated by draining water from the reactor. Such water is present in the reactor due to the necessity to flush the reactor at shutdown of the reactor. An example of a reactor useful in method 1400 is reactor 800 in FIG. 13. In the embodiment illustrated in FIG. 13, water is drained from reactor 800 through line 828 connected to the bottom of reactor 800. Valve V30 is provided in line 828 to control flow of water through line 828. Flushing of reactor 800 at shutdown is accomplished by flowing water into the bottom of reactor 800 and out the chlorine dioxide outlet 824 at the top of reactor 800. Water used to flush reactor 800 at shutdown is provided via line 840 which is in fluid communication with source of water 806. Valving assembly 802 is provided in line 840 between a source of water 806 and the bottom of reactor 800. In one embodiment, valving assembly 802 includes an auto flush valve to control delivery of water to reactor 800 Method 1400 includes step 1404 of heating a mixture of sodium chlorate and hydrogen peroxide to raise its temperature. In the embodiment illustrated in FIG. 13, the mixture of sodium chlorate and hydrogen peroxide is provided from the source 108 of sodium chlorate and hydrogen peroxide. In accordance with some embodiments of the present disclosure, the mixture of sodium chlorate and hydrogen peroxide contains 30-45% percent sodium chlorate and 4-12% hydrogen peroxide. Embodiments of the present disclosure are not limited to mixtures including the foregoing amounts of sodium chlorate and hydrogen peroxide. In the illustrated embodiment of FIG. 13, the amount of the mixture of sodium chlorate and hydrogen peroxide utilized is between about 3.5-5.5 lbs of the mixture per lb. of chlorine dioxide to be produced. Embodiments of the present disclosure are not limited to the foregoing amount of the mixture of sodium chlorate and hydrogen peroxide and use amounts of the mixture that fall below or above the foregoing range.

In step 1404, the temperature of the mixture of sodium chlorate and hydrogen peroxide is increased by introducing thermal energy into the mixture using a thermal energy input unit operation, such as a heat exchanger 816. Heat exchanger 816 is supplied with a fluid at an elevated temperature, e.g., water, which is heated by a heater 818. The embodiment of a system 804 for producing chlorine dioxide illustrated in FIG. 13, includes a metering pump 810 between heat exchanger 816 and source 108 of the mixture of sodium chlorate and hydrogen peroxide. Metering pump 810 is utilized to control the flow rate of the mixture of sodium chlorate and hydrogen peroxide through heat exchanger 816 and the flow rate of heated sodium chlorate and hydrogen peroxide into reactor 800. In accordance with some embodiments of the present disclosure, the temperature of the mixture of sodium chlorate and hydrogen peroxide entering the heat exchanger 816 is close to ambient temperature, which could be in the range of 30 to 100 degrees Fahrenheit. Embodiments in accordance with the present disclosure are not limited to utilizing a mixture of sodium chlorate and hydrogen peroxide entering the heat exchanger at a temperature that is in the range of 30 to 100° F. For example, in other embodiments, the temperature of the mixture of sodium chlorate and hydrogen peroxide entering the heat exchanger 816 is less than 30° F. or greater than 100° F. The degree to which the temperature of the mixture of sodium chlorate and hydrogen peroxide is increased in heat exchanger 816 can vary; however, in some embodiments, the temperature of the mixture is increased by 10° to 100° F. over ambient temperature. In other embodiments, the temperature of the mixture is increased less than 10° F. over ambient temperature or the temperature of the mixture is increased more than 100° F. over ambient temperature. In some embodiments, the temperature of the sodium chlorate and hydrogen peroxide mixture is increased above 130° F., but not in excess of 170° F. In other embodiments, the temperature of the sodium chlorate and hydrogen peroxide mixture is increased above 130° F., but not in excess of 150° F.

In step 1406, sulfuric acid and the heated mixture of sodium chlorate and hydrogen peroxide are supplied to reactor 800. As noted above, reactor 800 is devoid of water as a result of the prior draining of reactor 800 at step 1402. An example of a sulfuric acid useful in method 1400 and the system of FIG. 13 is 70 to 80% sulfuric acid solution, e.g., 78% sulfuric acid. In some embodiments, the amount of sulfuric acid pumped into the bottom of the reactor 800 is sufficient to provide between about 1.3 lbs to 3.0 lbs of acid per lb. of chlorine dioxide to be produced. In other embodiments, the amount of sulfuric acid pumped into the bottom of the reactor 800 is sufficient to provide between about 1.3 pounds to about 3.5 pounds of acid per pound of chlorine dioxide to be produced. At step 1406, the sulfuric acid and the heated mixture of sodium chlorate and hydrogen peroxide react in reactor 800 to produce chlorine dioxide. Conditions in reactor 800 result in a 90% or more conversion of chlorate. In some embodiments, the chlorate conversion is 95% or more. For example, the temperature of the reactants in the reactor 800 is between about 140° to 165° F. Embodiments in accordance with the present invention are not limited to the reactants in the reactor 800 being between 140° to 160° F. For example, in other embodiments, the temperature of the reactants in the reactor 800 is below 140° F. or above 160° F. In addition, embodiments in accordance with the present invention are not limited to a 90% conversion of chlorate, for example, in some embodiments of the present, the chlorate conversion is less than 90%. In some embodiments, the residence time of reactor 800 is less than about 15 minutes. Embodiments in accordance with the present disclosure are not limited to reactor 800 having a residence time less than about 15 minutes. For example, reactor 800 can have a residence time less than about 15, e.g., less than 10 minutes or less than 5 minutes. In other embodiments, reactor 800 has a residence time greater than 15 minutes.

At step 1408, chlorine dioxide produced in reactor 800 is removed via chlorine dioxide outlet 824. Produced chlorine dioxide is drawn out of reactor 800 due to a negative pressure relative to the reactor 800 produced by eductor 822.

At step 410, shut down of reactor 800, i.e., cessation of the production of chlorine dioxide is initiated by stopping one or more of the flow of sulfuric acid and the mixture of sodium chlorate and hydrogen peroxide to reactor 800. After the flow of sulfuric acid and the mixture of sodium chlorate and/or hydrogen peroxide to reactor 800 is stopped, valving assembly 802 is operated in a manner to flush sulfuric acid and the mixture of sodium chlorate and hydrogen peroxide in reactor 800 out of reactor 800 through chlorine dioxide outlet 824. See step 1412. Once flushing of reactor 800 is completed, at step 1414, method 1400 ends. In accordance with some embodiments of the present disclosure, the water used to flush the reactor 800 is retained within reactor 800 until startup of reactor 800 is initiated at step 1401. Retaining the water used to flush the reactor as shutdown leaves the reactor 800 in a safe condition, i.e., without insufficient hydrogen peroxide, sodium chlorate or sulfuric acid present to initiate a reaction at a time when reaction is not wanted or planned. For example, when reactor 800 is not filled or partially filled with water, it is possible hydrogen peroxide, sodium chlorate and sulfuric acid cold leak into reactor 800 from chemical sources 106 and 108 and initiate an unwanted reaction. As illustrated in FIG. 14, after method 1400 has ended it is restarted by returning to step 1401.

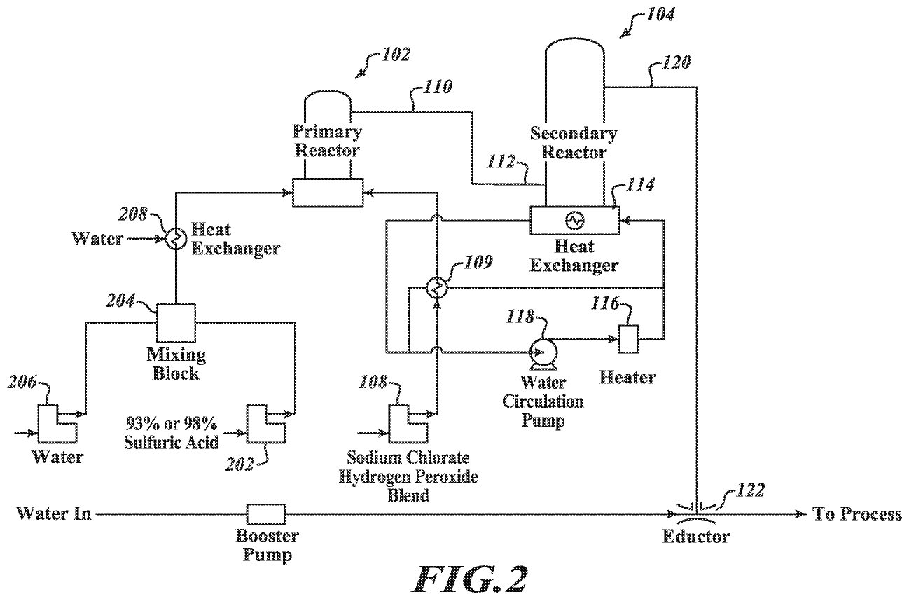

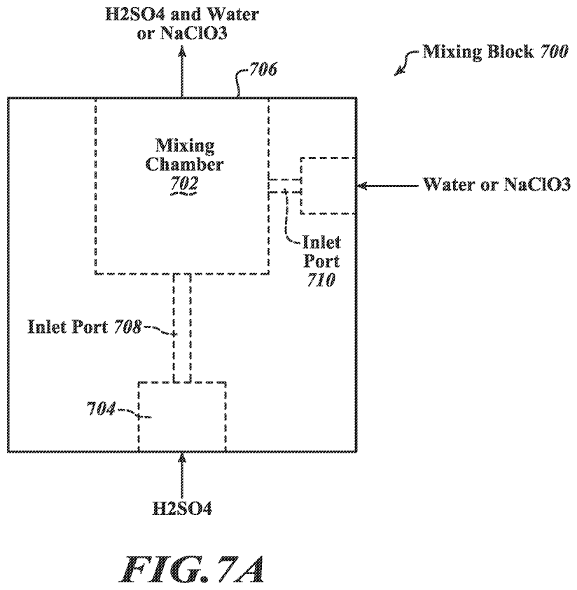

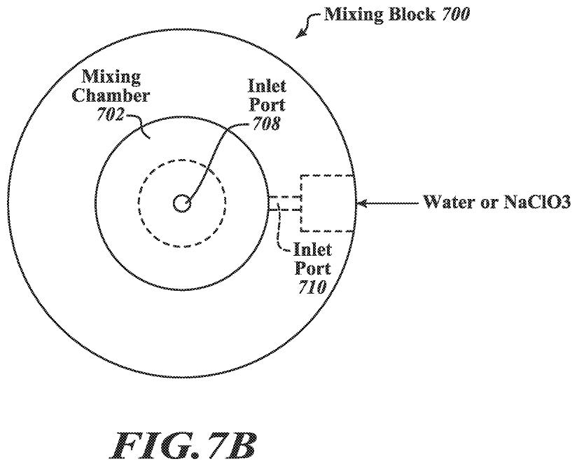

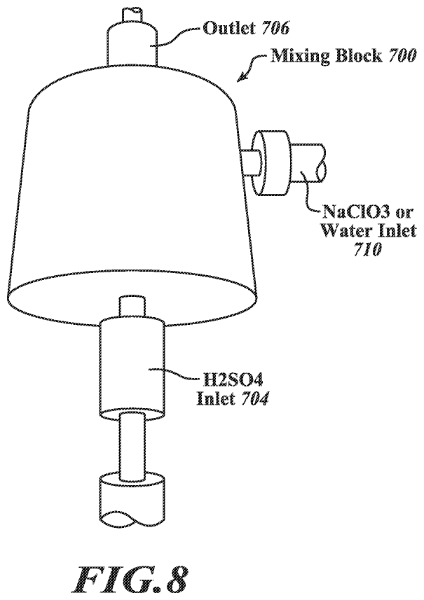

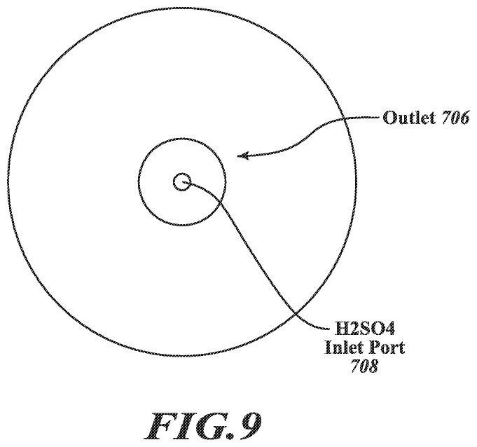

Referring to FIG. 2, another embodiment of the present disclosure utilizes the primary reaction stage 102, secondary reaction stage 104, source of sodium chlorate and hydrogen peroxide mixture 108, source of thermal energy 109, outlet 110 of primary reaction stage 102, inlet 112 of secondary reaction stage 104, thermal energy source 114, heater 116, pump 118, outlet 120 of secondary reaction stage 104 and educator 122 referred to with reference to the description of FIG. 1. The embodiment of a system for producing chlorine dioxide illustrated in FIG. 2 differs from the system for producing chlorine dioxide illustrated with reference to FIG. 1 in that 93% or 98% mineral acid is utilized instead of 78% mineral acid. The system of FIG. 2 includes a source 202 of 93%, 97% or 98% sulfuric acid. Source 202 of 93%, 97% or 98% sulfuric acid is in fluid communication with a mixing block 204, the details of which are described below in more detail with reference to FIGS. 7A, 7B, 8 and 9. Mixing block 204 is also in fluid communication with a source of water 206. Mixing block 204 receives acid from source 202 and water from source 206 and combines the two in mixing block 204 to produce diluted acid solution that is delivered to primary reaction stage 102. Mixing block mixes the concentrated acid and water in a way that dissipates a portion of the heat of solution. Additional cooling of the diluted acid solution can be provided by a cooling element 208 between mixing block 204 and primary reaction stage 102.

Cooling element 208 can be a heat exchanger. A description of the operation of the system illustrated in FIG. 1 is applicable to the system illustrated in FIG. 2. In an alternative embodiment of FIG. 2, the mineral acid is a 50% sulfuric acid. In such embodiment where the mineral acid is 50% sulfuric acid, cooling element 208 is reconfigured to be a heating element so that the temperature of the mixture leaving mixing block 204 can be increased to be within a range of about 120° to 140° F. In other embodiments, the thermal energy added to the mixture of sulfuric acid and water by the repurposed cooling element 208 elevates the temperature of the water/acid mixture to a range within about 115° F. to about 145° F. In other embodiments, the temperature of the water/acid mixture is elevated to within a range of about 125° F. to about 135° F. In yet other embodiments, the thermal energy added to the water/sulfuric acid mixture by repurposed cooling element 208 raises the temperature of the water/sulfuric acid to about 130° F.

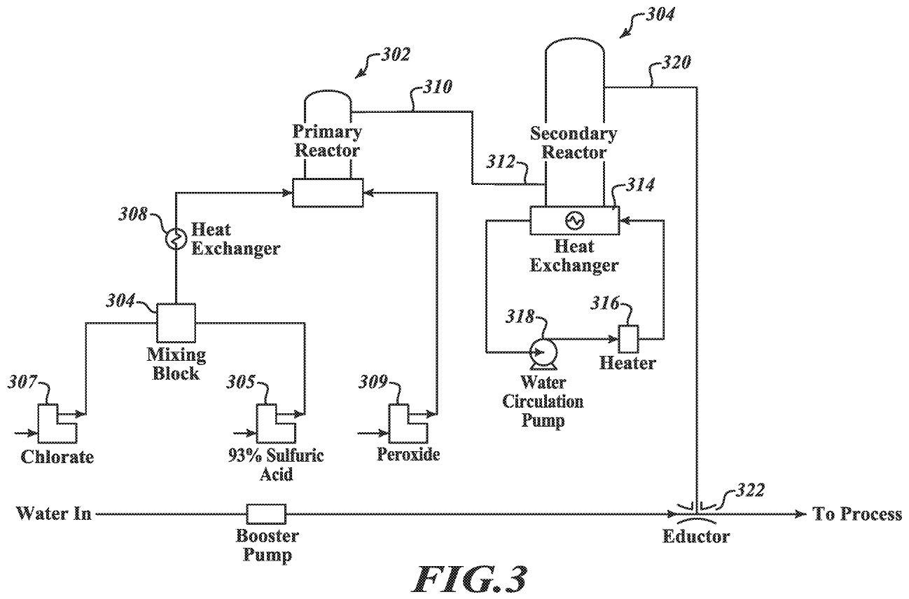

Referring to FIG. 3, another embodiment of the present disclosure utilizes a primary reaction stage 302, secondary reaction stage 304, outlet 310 of primary reaction stage 302, inlet 312 of secondary reaction stage 304, thermal energy source 314, heater 316, pump 318, outlet 320 of secondary reaction stage 304 and educator 322 that are the same as the primary reaction stage 102, secondary reaction stage 104, outlet 110 of primary reaction stage 102, inlet 112 of secondary reaction stage 104, thermal energy source 114, heater 116, pump 118, outlet 120 of secondary reaction stage 104 and educator 122 described with reference to FIG. 1. In accordance with the embodiment of FIG. 3, a highly concentrated mineral acid 305, e.g., an aqueous sulfuric acid solution containing 93 wt % or more sulfuric acid, e.g., 97 wt % or 98 wt % sulfuric acid, is combined with an alkali metal chlorate 307 in a mixing chamber of a mixing block 304 described below in more detail with reference to FIGS. 7A/7B, 8 and 9. The resulting mixture of acid and chlorate is cooled in a cooling heat exchanger 308. The cooled mixture of acid and chlorate flows to a primary reaction stage 302, where it is combined with hydrogen peroxide received by primary reaction stage 302 from a source of hydrogen peroxide 309. The sodium chlorate, hydrogen peroxide and sulfuric acid react in primary reaction stage 302 to produce chlorine dioxide. Chlorine dioxide, unreacted sodium chlorate, unreacted hydrogen peroxide, unreacted sulfuric acid and reaction byproducts are removed from primary reaction stage 302 through outlet 310 and delivered to secondary reaction stage 304 through inlet 312. The contents of secondary reaction stage 304 react to produce additional chlorine dioxide. Thermal energy is introduced to the contents of the secondary reaction stage 304 from source of thermal energy 314 in thermal communication with a bottom section of the secondary reaction stage 304. Source of thermal energy 314 receives circulating heating or cooling fluid provided by the heater 316 and pump 318. Contents of the secondary reaction stage number 304 are removed from the secondary reaction stage 304 via outlet 320. An eductor 322 produces a pressure differential which draws the contents of the secondary reactor through outlet 320.

In accordance with some embodiments described herein, when a 93 wt % acid or an acid of a higher concentration is fed at very high velocities into a mixing chamber, in accordance with some embodiments described herein, and mixed with water or an aqueous solution of sodium chlorate, the heat of solution is dissipated so local overheating does not occur. Local over heating of the acid/chlorate mixture can result in rapid production of chlorine dioxide which can then decompose to chlorine gas. In addition the mixing chamber is constructed such that when the chlorine dioxide reactor is shut down and feeding of acid and/or chlorate to the mixing chamber stops, there is virtually no further mixing or contact between the acid and chlorate, thereby minimizing the risk of local over heating when the reactor is shut down.

In the embodiment of FIG. 3, the acid chlorate mixture is cooled and then heated as in the description regarding FIG. 2. The advantage of mixing the chlorate with the acid directly is that when acid is premixed with water the water needs to be purified first before being mixed. If the water is not purified before mixing and deliver to the heat exchanger, it is very likely the heat exchanger will be scaled over due to the high temperatures of the acid/water mixture resulting from the heat of solution. Such scaling can quickly cause the generator to operate ineffectively.

In working with a three-reactant chemistry of sodium chlorate, sulfuric acid, and hydrogen peroxide, the resultant reaction can be extremely foamy. The foam is a drawback for several reasons. One drawback is the foam reduces residence time of the reactants in one or more of the respective reaction stages. Reduced residence time impedes the ability of the reactions to reach a high chlorate conversion efficiency to chlorine dioxide, particularly in the primary reaction stage. In accordance with embodiments of the present disclosure, challenges created by the presence of foam in the reaction stages are addressed by controlling the chemistry and reaction stage conditions such the any foam that is produced, quickly pools out, i.e., collapses, and does not significantly shorten the residence time of the particular reaction stage. For example, in accordance with some embodiments of the present disclosure, the primary reaction stage exhibits a residence time of up to 60 seconds. In other embodiments, the residence time is up to 45 seconds or is up to 30 seconds in length. It was observed that when residence times of these lengths are established for the primary reaction stage, chlorate conversions on the order of 50% or more is achieved in the primary reaction stage while utilizing less than 4 pounds of acid per pound of chlorine dioxide to be produced. In contrast, some single stage chlorine dioxide reactors systems use excess acid, e.g., more than 4 lbs of acid (e.g., 4.3 lbs or more) per lb. of chlorine dioxide to be produced to achieve chlorate conversion efficiencies of 95%. When these amounts of acid are utilized, additional costly chemicals are required to neutralize the unreacted acid that remains in the solution containing the chlorine dioxide. It has been observed that foam production can be controlled by controlling the normality of the solution in one or more of the primary or secondary reaction stages. For example, it has been observed that when the normality in a reaction stage is maintained below 11, e.g., between 9-10, foam produced while making chlorine dioxide becomes unstable and collapses (e.g., pools out) quickly as compared to when the reaction stage is maintained at a normality greater than about 11. This instability results in the foam breaking up and pooling out quickly in a reaction stage that has an inner diameter between about 6-24 inches. In accordance with some embodiments of the present disclosure, the first reaction stage has a residence time of less than 30 seconds and the second reaction stage has a residence time of at least 15 minutes.

Controlling the normality of the contents of the primary and second reactions stages to below 11, e.g., between 9-10 in accordance with embodiments described herein, is achieved by utilizing sulfuric acid in amounts described herein, e.g., less than 4 lbs of sulfuric acid for every lb. of chlorine dioxide to be produced, less than 3 lbs of sulfuric acid for every lb. of chlorine dioxide to be produced or less than 2 lbs of sulfuric acid for every lb. of chlorine dioxide to be produced.

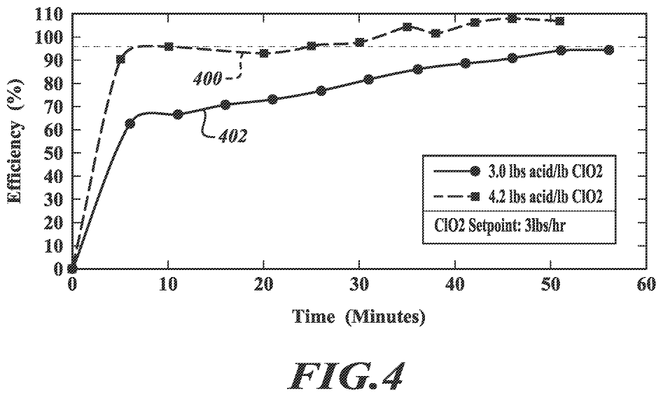

FIG. 4, shows a plot of conversion efficiency versus time for the production of 3 pounds of chlorine dioxide per hour utilizing 3 pounds of sulfuric acid per pound of chlorine dioxide to be produced (acid set point of 3 lbs acid/lb. ClO2) in accordance with an embodiment of the present disclosure. FIG. 4 also shows a plot of conversion efficiency versus time for producing 3 pounds of chlorine dioxide per hour utilizing 4.2 pounds of sulfuric acid per pound of chlorine dioxide to be produced (acid set point of 4.2 lbs acid/lb. ClO2).

As shown by FIG. 4, the efficiency of the 3 lb. acid/lb. ClO2 to be produced recipe carried out in a two stage reactor (in accordance with an embodiment of the present disclosure) without addition of thermal energy to the secondary reaction stage takes nearly one hour to reach 95% conversion efficiency (plot 402). In contrast, plot 400 illustrates how using more acid, i.e., 4.2 lb. acid/lb. ClO2 to be produced (such as used in conventional chlorine dioxide generators), will drive the reaction to 95% conversion efficiently significantly more quickly (e.g., in under 10 minutes). In accordance with some embodiments of the present disclosure, thermal energy is added to the secondary reaction stage, e.g., to the bottom of the secondary reaction stage to maintain the temperature of the contents in the secondary reaction stage, in a range of about 120 to 165 degree Fahrenheit or in a range of about 150 to 160 degrees Fahrenheit. Under these conditions in the secondary reaction stage, sodium chlorate in the secondary reaction stage is converted to additional chlorine dioxide.

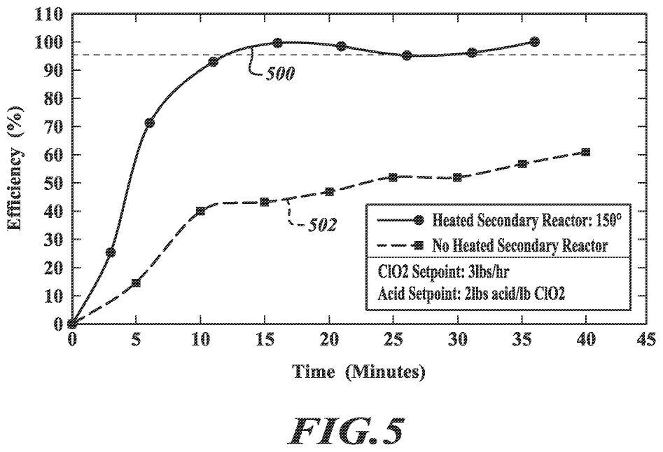

Referring to FIG. 5, the effect of introducing thermal energy to the secondary reaction stage as described above for a recipe that produces 3 lbs of chlorine dioxide per hour utilizing 2 lbs of sulfuric acid per lb. of chlorine dioxide to be produced is illustrated by plot 500. The results in FIG. 5 are for a secondary reaction stage where the temperature of the contents was 150° F.

FIG. 5 shows how utilizing a heated secondary reaction stage in a system for producing chlorine dioxide described herein achieves a 95% conversion efficiency between 10 and 15 minutes of combined residence time in the primary reaction stage and the secondary reaction stage. The temperature of the contents of the primary reaction stage and the secondary reaction stage, in accordance with an embodiment of the present disclosure, are well below the temperatures at which decomposition of chlorine dioxide would begin given the concentration of the chemicals in the primary reaction stage and the secondary reaction stage. This is in contrast to conventional chlorine dioxide generators which operate at temperatures above 130° F. and conditions which can lead to decomposition of the chlorine dioxide. A factor that contributes to the ability to operate embodiments in accordance with the present invention at temperatures higher than temperatures where conventional chlorine dioxide generators decompose chlorine dioxide is the low concentration of the reactants in the secondary reaction stage of some embodiments of the present disclosure. The low concentration of reactants in the secondary reaction stage is in partly attributable to the primary reaction stage reducing the concentration of sodium chlorate through the chlorine dioxide producing reaction that occurs in the primary reaction stage and the amount of acid provided by the acid feed to the primary reaction stage being less than the amount of acid utilized in conventional chlorine dioxide generators.

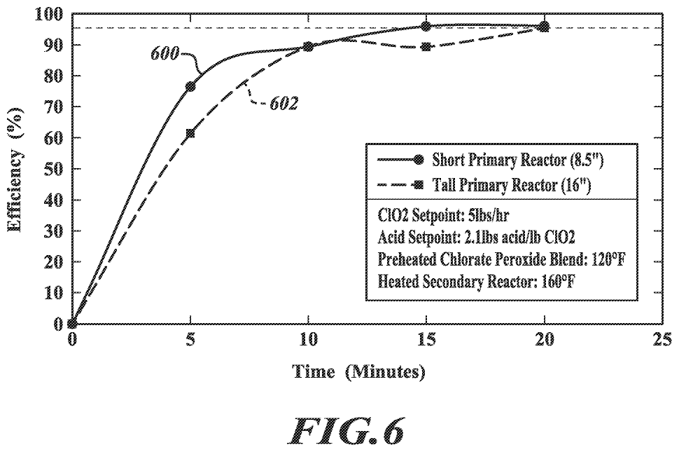

In accordance with some embodiments of the present description, the outlet of the first reaction stage and the inlet of the second reaction stage are designed so that the outlet of the first reaction stage is at the top section of the first reaction stage and the inlet of the second reaction stage is at the bottom section (e.g., in the bottom one third) of the second reaction stage. The second reaction stage also includes an outlet at the top section of the second reaction stage. In addition, in some embodiments, the outlet of the first reaction stage is below the outlet of the secondary reaction stage. It was observed that when the outlet of the first reaction stage is below the outlet of the second reaction stage, fluid from the second reaction stage flows backwards to the primary reactor. This can result in surging in the first reaction stage which contributes to inconsistent results from the standpoint of conversion of sodium chlorate to chlorine dioxide. Referring to FIG. 6, the impact of the primary reaction stage and its size can be seen in FIG. 6. In FIG. 6, sodium chlorate conversion efficiency is reported as a function of time in a system for producing chlorine dioxide in accordance with an embodiment of the present disclosure, wherein the primary reaction stage is either 8.5 inches long (plot 600), or 16 inches long (plot 602) and the contents of the secondary reaction stage are at a temperature of about 160° F. The production rate for chlorine dioxide was 5 pounds per hour and 2.1 pounds of acid per pound of chlorine dioxide to be produced was provided to the primary reaction stage. Prior to delivery of the sodium chlorate and hydrogen peroxide to the primary reaction stage, the mixture of two components was heated to 120° F. FIG. 6 illustrates that 95% conversion of sodium chlorate was achieved for the system within the 8.5 inch long primary reaction stage in about 15 minutes and 95% conversion of the system with the 16 inch long primary reaction stage was achieved in about 20 minutes. A benefit of a shorter primary reactor is that starting up the system is quicker when the primary reactor vessel is smaller. As the system starts up, water in the primary reaction stage left over from a previous shutdown procedure is flushed out. The cold water in the primary reaction stage absorbs/dissolves the sulfuric acid, hydrogen peroxide and sodium chlorate; however, heat of solution for the acid does not raise temperature of the primary reactor sufficiently to drive the reaction of chlorate to chlorine dioxide. To startup an embodiment of a system in accordance with the present disclosure, sodium chlorate, hydrogen peroxide and sulfuric acid are fed to the primary reaction stage. Flushed water and the sodium chlorate, hydrogen peroxide and sulfuric acid flows to the secondary reaction stage where its temperature can be increased by the source of thermal energy. The elevated temperature of the contents of the secondary reaction stage is used to drive the chlorine producing reaction in the secondary reactor so that 95% or greater conversion is achieved quickly. For example, to elevate the reactivity in the primary reaction stage, the primary reaction stage is designed to have a residence time of less than 60 seconds. As the contents of the primary reaction stage moved to the secondary reaction stage, the integral heat exchanger will increase the temperature of the contents of the secondary reaction stage and thereby increase the rate of reaction so that an overall target 95% conversion efficiency by the primary reaction stage in the secondary reaction stage is achieved.

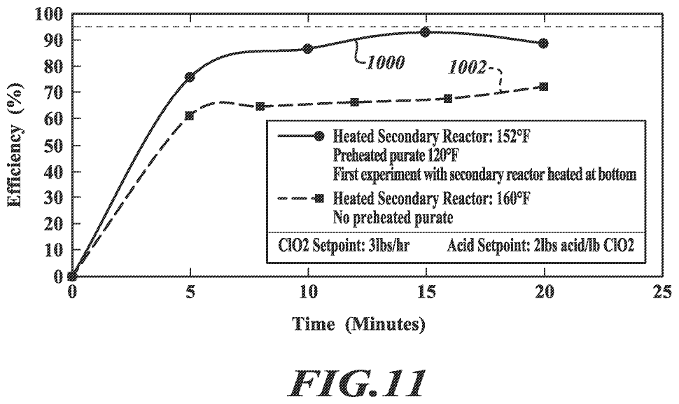

Referring to FIG. 1 and FIG. 11, in accordance with an embodiment of the present disclosure, a mixture of sodium chlorate and hydrogen peroxide is heated by heater 109 prior to delivery of the mixture of sodium chlorate and hydrogen peroxide to primary reaction stage 102. In FIG. 11, plots 1000 and 1002 show conversion efficiency versus time for the production of 3 lbs of chlorine dioxide per hour utilizing 2 lbs of sulfuric acid per lb. of chlorine dioxide to be produced (acid set point of 2 lbs acid/lb. chlorine dioxide) for a reactor in accordance with a system for producing chlorine dioxide in accordance with one embodiment of the present disclosure. Plot 1000 represents conversion efficiency when the mixture of hydrogen peroxide and sodium chlorate is preheated to 120° F. before feeding the mixture to the primary reaction stage 102 and operating the secondary reaction stage 104 at a temperature of about 152° F. Plot 1002 represents conversion efficiency when the mixture of hydrogen peroxide and sodium chlorate was at ambient temperature (i.e., was not preheated) when fed to the primary reaction stage 102, with the secondary reaction stage operated at a temperature of about 160° F. As illustrated in FIG. 11, preheating the sodium chlorate and hydrogen peroxide mixture to 120° F. prior to introduction into the primary reaction stage 102 produced a 90% or greater conversion in less than 15 minutes. It has been observed that heating the mixture of hydrogen peroxide and sodium chlorate to even 160° F. produced acceptable and in cases where the generator chemicals are initially at ambient temperatures, this higher temperature is beneficial to producing chlorine dioxide quickly. In contrast, in the absence of preheating, at 15 minutes, a conversion efficiency of slightly greater than 65% was achieved and a conversion efficiency slightly above 70% was achieved after 20 minutes of operation. These results would show an even greater difference if the reactants had been even colder, e.g., 45 degree ° F. where the efficiency would be much lower.

Referring to FIGS. 7A, 7B, 8 and 9, a mixing block 700 including a mixing chamber 702 in accordance with embodiments described herein is illustrated. The mixing block 700 includes a mixing chamber 702, which receives sulfuric acid via an inlet port 704 which communicates between the mixing chamber 702 and an exterior of the mixing block 700. The mixing chamber 702 includes and outlet 706 through which the acid/chlorate mixture or the diluted acid solution exits the mixing chamber 702 and is delivered to the heat exchanger in FIGS. 2 and 3. Acid is fed into the bottom of the mixing block 700 and is delivered into the mixing chamber 702 through a hole/inlet port 708 that, in some embodiments, is 1/16 to 3/16 inches in diameter. In accordance with other embodiments, the hole 708 which delivers the acid to the mixing chamber 702 has a diameter that is less than or greater than the above range. The acid is delivered into the mixing chamber 702 under a pressure that is greater than 25 psig but less than 200 psig, e.g., a pressure between 70 psig to 100 psig. The pressure, diameter of inlet port 708 and volume of acid can be varied such that the acid is introduced into the mixing chamber at a velocity of 3 to 20 meter/second. At these speeds, the acid mixes quickly with the sodium chlorate or water and a portion of the heat of solution is dissipated. When the acid is mixed with sodium chlorate in the mixing block 700, the heat of solution is dissipated sufficiently to maintain the temperature of the mixture below temperatures where chlorine dioxide would otherwise form in the mixing chamber 702 and/or decompose to chlorine gas. For example, the temperature of the acid/chlorate mixture as it exits the mixing chamber 702 is below a temperature where a significant amount of chlorine dioxide would be produced, e.g., below about 170 degrees F.

The chlorate or water is fed into the side of the mixing block 700 and into the mixing chamber 702 through a hole/inlet port 710 that, in some embodiments, is 1/16 to 3/16 inches in diameter. In accordance with other embodiments, the hole that delivers the chlorate or water to the mixing chamber 702 has a diameter that is less than or greater than the range described in the previous sentence. The chlorate or water is delivered into the mixing chamber 702 under a pressure that is greater than 25 psig but less than 200 psig, e.g., a pressure between 70 psig to 100 psig. The pressure, diameter of inlet port 710 and volume of chlorate or water can be varied such that the chlorate or water is introduced into the mixing chamber 702 at a velocity of 3 to 20 meter/second. At these speeds, the chlorate or water mixes extremely fast with the acid and the heat of solution is dissipated sufficiently. When chlorate is mixed with the acid in mixing chamber 702, the dissipation of the heat of solution is sufficient to maintain the temperature of the mixture below temperatures where chlorine dioxide would otherwise form in the mixing chamber 702 or decompose to chlorine gas. For example, the temperature of the acid/chlorate mixture as it exits the mixing chamber 702 is below about 170 degrees F.

In accordance with embodiments described herein, the speed and pressures under which the acid is introduced into the mixing chamber can be higher or lower than the speeds described above. These speeds with which the acid and the chlorate or water are introduced into the mixing chamber can be varied so that the speed of the acid and the speed of the chlorate or water are different, provided the heat of solution is dissipated sufficiently.

In one embodiment of a system for producing chlorine dioxide that includes the primary reaction stage 102 and the secondary reaction stage 104 in accordance with the present disclosure, the primary reaction stage and the secondary reaction stage are tubular reactors having a round cross-section.

The primary reaction stage and the secondary reaction stage are formed from materials that are resistance to chlorine dioxide and the chemicals used to produce chlorine dioxide. Examples of such materials include stainless steel, an ethylene chlorotrifluoroethylene (tradenaname Halar), tantalum and blends of tantalum and tungsten. The various piping and other components of systems formed in accordance with the present disclosure are likewise formed from materials that are chemically resistant to the reactants, products, and byproducts associated with conversion of chlorate to chlorine dioxide.

In some embodiments, the primary reactor has an inner diameter of about 2-4 inches, e.g., 3 inches, and a length of up to about 24 inches, e.g., 24 inches, 18 inches 12 inches or less. In some embodiments, the secondary reaction stage has an inner diameter of about 5-24 inches, e.g., about 6 inches and a length of about 24-48 inches. Other embodiments of the present disclosure include a primary reaction stage that has an inner diameter that is less than or greater than the specific values given above, and has a length that is less than or greater than the specific values given above. For example, in some embodiments, the primary reaction stage has an inner diameter that is less than 2 inches or greater than 4 inches and has a length that is less than 24 inches or greater than 24 inches. Other embodiments of the present disclosure include a secondary reaction stage that has an inner diameter that is less than or greater than the specific values given above, and has a length that is less than or greater than the specific values given above. For example, in other embodiments of the present disclosure, the secondary reaction stage has an inner diameter that is less than 5 inches or greater than 24 inches and a length that is less than 24 inches or greater than 48 inches, e.g., up to 30 inches, up to 40 inches, up to 50 inches, up to 60 inches or longer.

In one embodiment, the heat exchanger 114 in FIG. 1 utilized for introducing thermal energy into the bottom of the secondary reaction stage 104 is formed from tantalum, but higher stainless steels may also be utilized. The base of the heat exchanger includes an ethylene chlorotrifluoroethylene (tradename Hadar) material but other materials such as polytetrafluoroethylene (tradename Teflon) or chlorinated polyvinylchloride could also be used.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including U.S. Provisional Patent Application No. 63/063,659, filed on Aug. 10, 2020, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system for producing chlorine dioxide comprising:
a source of sodium chlorate;
a source of hydrogen peroxide;
a source of sulfuric acid;
a flow inducing device, which, in operation, induces a flow of the sodium chlorate, hydrogen peroxide and sulfuric acid;
a primary reaction stage, the primary reaction stage including a tubular vessel having a residence time of up to 60 seconds based on volumetric flow of the sodium chlorate, hydrogen peroxide and sulfuric acid into the tubular vessel of the primary reaction stage;
a secondary reaction stage in fluid communication with the primary reaction stage, the secondary reaction stage including a tubular vessel having a residence time of up to 30 minutes based on volumetric flow of fluid out of the primary reaction stage; and
a source of thermal energy in thermal communication with the secondary reaction stage.

2. The system of claim 1, wherein the primary reaction stage includes a top and the secondary reaction stage includes a bottom, the top of the primary reaction stage including a discharge connection and the bottom one third of the secondary reaction stage including in inlet connection, the discharge connection in fluid communication with the inlet connection and the discharge connection being above the inlet connection.

3. The system of claim 1, further comprising a source of thermal energy for introducing thermal energy to one or more of the sodium chlorate and the hydrogen peroxide, the source of thermal energy introducing the thermal energy between one or more of the source of sodium chlorate and the source of hydrogen peroxide and the primary reaction stage.

4. The system of claim 1, wherein the sulfuric acid has a concentration of 93% or higher and the system further comprises a mixing block including:
an inlet, which, in operation, receives the sulfuric acid from the source of sulfuric acid;
an inlet, which, in operation, receives water;
a mixing chamber in fluid communication with the inlet that receives water and in fluid communication with the inlet that received sulfuric acid; and
an outlet in fluid communication with the mixing chamber and in fluid communication with the primary reaction stage.

5. (canceled)

6. The system of claim 5, further comprising a source of thermal energy between the mixing chamber and the primary reaction stage.

7. A method for producing chlorine dioxide comprising:
contacting sodium chlorate, hydrogen peroxide and sulfuric acid in a primary reaction stage, the amount of sulfuric acid contacted with the sodium chlorate and the hydrogen peroxide being between about 1.3 lbs to about 3.5 lbs of sulfuric acid per lb. of chlorine dioxide to be produced;
reacting the sodium chlorate, the hydrogen peroxide and the sulfuric acid in the primary reaction stage, the reacting consuming 50% or more of the sodium chlorate within 60 seconds of the contacting the sodium chlorate, the hydrogen peroxide and the sulfuric acid in a primary reaction stage;
discharging, from a top of the primary reaction stage, contents of the primary reaction stage to a bottom one third of a secondary reaction stage; and
maintaining the contents of the secondary reaction stage below 172° F.

8. The method of claim 7, further comprising reacting sodium chlorate, hydrogen peroxide and sulfuric acid within the secondary reaction stage to produce chlorine dioxide.

9. The method of claim 8, wherein 95% or more of the sodium chlorate contacted with the hydrogen peroxide and sulfuric acid in the primary reaction stage is consumed in the primary reaction stage and the secondary reaction stage.

10. The method of claim 8, wherein the amount of sulfuric acid contacted with the sodium chlorate and hydrogen peroxide in the primary reaction stage is between about 1.8 lbs to about 2.2 lbs of sulfuric acid per lb of chlorine dioxide to be produced.

11. The method of claim 7, wherein normality of contents of the secondary reaction stage is below 11.

12. The method of claim 7, wherein sodium chlorate molarity of contents of the secondary reaction stage is less than 1.

13. The method of claim 7, wherein residence time of the primary reaction stage is less than about 60 seconds.

14. The method of claim 7, wherein residence time of the secondary reaction stage is less than 30 minutes.

15. The method of claim 7, wherein the sodium chlorate and the hydrogen peroxide enter the primary reaction stage at a temperature of between about 10° F. to about 80° F. above ambient temperature and not in excess of 170° F.

16. The method of claim 7, wherein temperature of contents of the secondary reaction stage is maintained between 130° F. and 170° F.

17. A method for producing chlorine dioxide comprising:
receiving a mixture of sodium chlorate and hydrogen peroxide in a thermal energy input unit:
increasing the temperature of the mixture of sodium chlorate and hydrogen peroxide in the thermal energy input unit
after increasing the temperature of the mixture of sodium chlorate and hydrogen peroxide, contacting the mixture of sodium chlorate and hydrogen peroxide with 78% or less sulfuric acid in a reaction stage, the amount of sulfuric acid contacted with the mixture of sodium chlorate and the hydrogen peroxide being between about 1.3 lbs to about 3.5 lbs of sulfuric acid per lb. of chlorine dioxide to be produced;
reacting the sodium chlorate, the hydrogen peroxide and the 78% or less sulfuric acid in the reaction stage, the reacting consuming 90% or more of the sodium chlorate;
removing chlorine dioxide from the reaction stage;
stopping the reacting by stopping flow of one or more of the mixture of sodium chlorate an hydrogen peroxide and the 78% or less sulfuric acid to the reaction stage;
flushing the reaction stage with water;
retaining water within the reaction stage; and
initiating startup of the reaction stage by draining the reaction stage of water.

18. The method of claim 17, wherein the reacting consumes 95% or more of the sodium chlorate.

19. The method of claim 17, wherein a temperature of the sodium chlorate, the hydrogen peroxide and the 78% or less sulfuric acid in the reaction stage is between 140° to 160° F. during the reacting step.

20. The method of claim 17, further comprising introducing thermal energy to a bottom of the reaction stage.

21. The method of claim 17, wherein the increasing the temperature of the mixture of sodium chlorate and hydrogen peroxide in the thermal energy input unit includes increasing the temperature of the mixture to between 130° F. and 170° F.
